(19) United States
(12) Patent Application Publication
(10) Pub. No.: US 2026/0264065 A1
(43) Pub. Date: Sep. 10, 2026

(54) CATALYSTS FOR THE REDUCTION OF CARBON DIOXIDE

(71) Applicant: DIMENSIONAL ENERGY, INC., Ithaca, NY (US)

(72) Inventors: Bradley J. Brennan, Omaha, NE (US); Ali Sangghaleh, Ithaca, NY (US)

(21) Appl. No.: 18/872,056

(22) PCT Filed: May 30, 2023
(86) PCT No.: PCT/US2023/023868

§ 371 Date: Dec. 5, 2024

Related U.S. Application Data
(60) Provisional application No. 63/351,896, filed on Jun. 14, 2022.

(51) Int. Cl. B01J 27/22; C01B 32/40

(52) U.S. Cl. CPC B01J 27/22; C01B 32/40

(57) ABSTRACT

Catalytic materials for use in carbon dioxide reduction reactions, such as during a dry reforming methane reaction or a reverse water gas shift reaction. The catalytic materials can include a MAX or MAX-LIKE phase material and a solid support. Also described are methods of performing a carbon dioxide reduction reaction using the catalytic materials and methods of preparing a catalytic material that includes a MAX or MAX-LIKE phase material.

### CROSS-REFERENCE TO RELATED APPLICATION

This application claims benefit of U.S. Provisional Application No. 63/351,896 filed on Jun. 14, 2022. U.S. Provisional Application No. 63/351,896 is incorporated herein by reference. A claim of priority is made.

### GOVERNMENT LICENSE RIGHTS

This invention was made with government support under contract number IIP-1853888 awarded by the National Science Foundation, Division of Industrial Innovation and Partnerships, and under contract number DMR-1719875 awarded by the National Science Foundation, Division of Materials Research. The government has certain rights in the invention.

### BACKGROUND

There is considerable interest in reducing the world's dependence on fossil fuels to halt or slow the emission of carbon dioxide. Presently, the chemical and energy industries rely on fossil fuels as a source of their carbon feedstocks, and a majority of the world's plastics and fuels are produced from fossil fuels. It would be beneficial to find alternative sources of feedstocks for those industries.

One potential method of producing such alternative carbon feedstocks is the reverse water-gas shift reaction (the “RWGS reaction”). The RWGS reaction was discovered in the 19th century as a method for producing water from carbon dioxide and hydrogen, with carbon monoxide as a side product. Equation 1 illustrates the RWGS reaction which involves the reduction of carbon dioxide and the oxidation of hydrogen to form carbon monoxide and water:

$$\begin{matrix}{CO}_{2} + {H}_{2} ↔ CO + {H}_{2} O & Δ {H}_{rxn} = 41.19 kJ / mol\end{matrix} \qquad ( Equation 1 )$$

Carbon monoxide is itself a versatile feedstock useful in the production of a wide range of chemical products. For example, carbon monoxide can be hydrogenated to form various liquid fuels (e.g., diesel, gasoline, and alcohols). Hence, the RWGS reaction scheme provides a method of producing carbon feedstocks from atmospheric carbon dioxide rather than fossil fuels.

A second potential method of producing such alternative carbon feedstocks is the dry reforming of methane reaction (the “DRM reaction”). The DRM reaction is a method of producing synthesis gas from a reaction of carbon dioxide with a hydrocarbon. Equation 2 illustrates the DRM reaction with methane as the hydrocarbon:

$$\begin{matrix}{CH}_{4} + {CO}_{2} ↔ 2 {H}_{2} + 2 CO & Δ {H}_{rxn} = 260.5 kJ / mol\end{matrix} \qquad ( Equation 2 )$$

In this reaction, carbon dioxide is reduced and methane is oxidized to form hydrogen and carbon monoxide. Hence, in this DRM reaction, two greenhouse gases (methane and carbon dioxide) are consumed and used to create the synthesis gas mixture of hydrogen and carbon monoxide.

Conventional catalytic materials for the RWGS reaction and the DRM reaction suffer from coking, sintering, and poor stability and/or activity. Further, these conventional catalytic materials can be expensive and may require frequent replacement. Accordingly, the efficiency and performance of the RWGS reaction and the DRM reaction may be improved by utilizing improved catalytic materials and methods useful in the production of carbon feedstocks.

### SUMMARY

The present disclosure is directed towards novel and inventive catalysts for use in chemical reactions that reduce carbon dioxide to carbon monoxide, as well as methods of using and preparing such catalysts.

According to one aspect, a solid catalyst for catalyzing the reduction of carbon dioxide includes a MAX or MAX-LIKE phase material having the chemical formula M_{b+1}A_{d}JₑX_{f}, wherein M is a transition metal, A is an element from Group A, J is a dopant, and X is either carbon or nitrogen, and wherein b is either 1, 2, or 3; d is either 0, 1, 2, or 3; e is either 0, 1, 2, or 3; and f is either 1, 2, 3, or 4.

According to another aspect, a method of performing a carbon dioxide reduction reaction includes providing a catalyst, wherein the catalyst includes: a MAX or MAX-LIKE phase material having the chemical formula M_{b+1}A_{d}JₑX_{f}, wherein M is a transition metal, A is an element from Group A, J is a dopant, and X is either carbon or nitrogen, and wherein b is either 1, 2, or 3; d is either 0, 1, 2, or 3; e is either 0, 1, 2, or 3; and f is either 1, 2, 3, or 4; and contacting the catalyst with carbon dioxide to reduce the carbon dioxide.

According to another aspect, a method of preparing a catalyst includes providing a MAX or MAX-LIKE phase material having the chemical formula M_{b+1}A_{d}JₑX_{f}, wherein M is a transition metal, A is an element from Group A, J is a dopant, and X is either carbon or nitrogen, and wherein b is either 1, 2, or 3; d is either 0, 1, 2, or 3; e is either 0, 1, 2, or 3; and f is either 1, 2, 3, or 4; providing a solid support material; and securing the MAX or MAX-LIKE phase material to the solid support material to form the catalyst.

This summary is intended to provide an overview of subject matter of the present disclosure. It is not intended to provide an exclusive or exhaustive explanation of the novel catalyst for use in carbon dioxide reduction reactions. The detailed description is included to provide further information about the present patent application.

### BRIEF DESCRIPTION OF THE DRAWINGS

This written disclosure describes illustrative embodiments that are non-limiting and non-exhaustive. Reference is made to illustrative embodiments that are depicted in the figures, in which:

FIG. 1 illustrates method 100 of performing a carbon dioxide reduction reaction, according to some embodiments.

FIG. 2 illustrates method 200 of preparing a catalyst, according to some embodiments.

FIG. 3A illustrates an SEM image of one embodiment of a catalyst, according to some embodiments.

FIG. 3B illustrates an SEM image of one embodiment of a catalyst, according to some embodiments.

FIG. 4 illustrates an SEM image of one embodiment of a catalyst, according to some embodiments.

FIG. 5 illustrates a graph of carbon dioxide conversion measurements by various catalytic materials during a catalytic test, according to some embodiments.

FIG. 6 illustrates a graph of the amount of methanol generated by various catalytic materials, according to some embodiments.

FIG. 7 illustrates a graph of the amount of methane generated by various catalytic materials, according to some embodiments.

FIG. 8 illustrates a graph of the carbon dioxide conversion based on reaction temperature, by various catalytic materials, according to some embodiments.

FIG. 9 illustrates a graph of carbon dioxide conversion measurements made during a catalytic stability test, according to some embodiments.

### DETAILED DESCRIPTION

The present disclosure is directed toward solid catalysts for use in a carbon dioxide reduction reaction. In some embodiments, the catalysts are used to reduce carbon dioxide to form carbon monoxide. For example, embodiments of the present disclosure are useful in catalyzing the reduction of carbon dioxide and the oxidation of hydrogen in the RWGS reaction illustrated in Equation 1 and/or the reduction of carbon dioxide and the oxidation of methane in the DRM reaction illustrated in Equation 2.

In some embodiments, the catalyst includes one or more “MAX or MAX-LIKE phase materials” which are defined herein as a material having the chemical formula shown below as Formula 1:

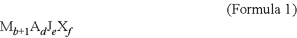

where M is a transition metal (e.g., scandium, yttrium, lutetium, titanium, zirconium, hafnium, vanadium, niobium, tantalum, chromium, molybdenum, tungsten, manganese, or iron); A is a Group A element (e.g., iridium, palladium, copper, gold, zinc, cadmium, aluminum, gallium, indium, thallium, silicon, germanium, tin, lead, phosphorous, arsenic, bismuth, or sulfur); J is a dopant; and X is either carbon or nitrogen. The MAX or MAX-LIKE phase material catalysts are catalytically active and promote chemical reactions (e.g., a RWGS and/or a DRM reaction). In one example, M may be two or more transition metals selected from scandium, yttrium, lutetium, titanium, zirconium, hafnium, vanadium, niobium, tantalum, chromium, molybdenum, tungsten, manganese, and iron. For example, M in Formula 1 may include “(M₁₋ₓMₓ), where 0<x<1. In another example, in Formula 1, b is either 1, 2, or 3; d is either 0, 1, 2, or 3; e is either 0, 1, 2, or 3; and f is either 1, 2, 3, or 4. In yet another example, in Formula 1, b is either 1, 2, or 3; d is either 1, 2, or 3; e is either 0, 1, 2, or 3; and f is either 1, 2, 3, or 4.

J may be a dopant selected from one or more of scandium, yttrium, lutetium, titanium, zirconium, hafnium, vanadium, niobium, tantalum, chromium, molybdenum, tungsten, manganese, iron, iridium, palladium, copper, gold, zinc, cadmium, aluminum, gallium, indium, thallium, silicon, germanium, tin, lead, phosphorous, arsenic, bismuth, sulfur, carbon, and nitrogen. J may be a dopant selected from two or more of scandium, yttrium, lutetium, titanium, zirconium, hafnium, vanadium, niobium, tantalum, chromium, molybdenum, tungsten, manganese, iron, iridium, palladium, copper, gold, zinc, cadmium, aluminum, gallium, indium, thallium, silicon, germanium, tin, lead, phosphorous, arsenic, bismuth, sulfur, carbon, and nitrogen. J may be a dopant selected from a transition metal such as scandium, yttrium, lutetium, titanium, zirconium, hafnium, vanadium, niobium, tantalum, chromium, molybdenum, tungsten, manganese, or iron. J may be a dopant selected from a group A element such as iridium, palladium, copper, gold, zinc, cadmium, aluminum, gallium, indium, thallium, silicon, germanium, tin, lead, phosphorous, arsenic, bismuth, or sulfur.

According to Formula 1, the MAX or MAX-LIKE phase material may include the following formula: M_{b+1}AX_{f}, where b is either 1, 2, or 3 and f is either 1, 2, 3, or 4. In the preceding sentence, b and f may be equal. In another example, the MAX or MAX-LIKE phase material may include the following formula: M_{b+1}A_{d}X, where b is either 1, 2, or 3 and d is either 1, 2, or 3. In another example, the MAX or MAX-LIKE phase material may include the following formula: M_{b+1}A_{d}JX_{f}, where b is either 1, 2, or 3; d is either 1, 2, or 3; and f is either 1, 2, 3, or 4. In another example, the MAX or MAX-LIKE phase material may include the following formula: M_{b+1}A_{d}JX, where b is either 1, 2, or 3 and d is either 0, 1, 2, or 3. In yet another example, the MAX or MAX-LIKE phase material may include the following formula: M_{b+1}X_{f}, where b is either 1, 2, or 3 and f is either 1, 2, 3, or 4.

According to Formula 1, the MAX or MAX-LIKE phase material may include one or more of the following formulas: M₂AX, M₂AX₂, M₂AX₃, M₃AX, M₃AX₂, M₃AX₃, M₄AX, M₄AX₂, and M₄AX₃. According to Formula 1, the MAX or MAX-LIKE phase material may include one or more of the following formulas: M₂AX, M₂A₂X, M₂A₃X, M₃AX, M₃A₂X, M₃A₃X, M₄AX, M₄A₂X, and M₄A₃X. According to Formula 1, the MAX or MAX-LIKE phase material may include one or more of the following formulas: M₂AJX, M₂A₂JX, M₂A₃JX, M₃AJX, M₃A₂JX, M₃A₃JX, M₄AJX, M₄A₂JX, M₄A₃JX, M₂AJX₂, M₂A₂JX₂, M₂A₃JX₂, M₃AJX₂, M₃A₂JX₂, M₃A₃JX₂, M₄AJX₂, M₄A₂JX₂, M₄A₃JX₂, M₂AJX₃, M₂A₂JX₃, M₂A₃JX₃, M₃AJX₃, M₃A₂JX₃, M₃A₃JX₃, M₄AJX₃, M₄A₂JX₃, and M₄A₃JX₃. According to Formula 1, the MAX or MAX-LIKE phase material may include one or more of the following formulas: M₂X, M₂X₂, M₂X₃, M₃X, M₃X₂, M₃X₃, MAX, M₄X₂, and M₄X₃.

In one non-limiting example, the MAX or MAX-LIKE phase material may include one or more of the following formulas where M is Mo (molybdenum): Mo₂AX, Mo₂AX₂, Mo₂AX₃, Mo₃AX, Mo₃AX₂, Mo₃AX₃, Mo₄AX, Mo₄AX₂, and Mo₄AX₃. In another non-limiting example, the MAX or MAX-LIKE phase materials may include A, where A is In (Indium), Ga (Gallium), or Al (Aluminum). In yet another non-limiting example, the MAX or MAX-LIKE phase materials may include one or more of the following formulas where M is Mo: Mo₂AX, Mo₂A₂X, Mo₂A₃X, Mo₃AX, Mo₃A₂X, Mo₃A₃X, Mo₄AX, Mo₄A₂X, and Mo₄A₃X. In yet another non-limiting example, the MAX or MAX-LIKE phase materials may include one or more of the following formulas where X is C (Carbon): M₂AC, M₂AC₂, M₂AC₃, M₃AC, M₃AC₂, M₃AC₃, M₄AC, M₄AC₂, and M₄AC₃. In yet another non-limiting example, the MAX or MAX-LIKE phase materials may include one or more of the following formulas where X is N (Nitrogen): M₂AN, M₂AN₂, M₂AN₃, M₃AN, M₃AN₂, M₃AN₃, M₄AN, M₄AN₂, and M₄AN₃.

The MAX or MAX-LIKE phase material may include Mo₂InC. In another example, the MAX or MAX-LIKE phase material may include Mo₂Ga₂C. In yet another example, the MAX or MAX-LIKE phase material may include Mo₂Ti₂AlC₃. In yet another example, the MAX or MAX-LIKE phase material may include Mo₂TiAlC₂. In yet another example, the MAX or MAX-LIKE phase material may include Ti₂SnC. In yet another example, the MAX or MAX-LIKE phase material may include Mo₂C. In one example, the MAX or MAX-LIKE phase material of M_{b+1}A₂X may include an extra layer of atoms in the unit cell, compared to M_{b+1}AX_{f}. For example, the MAX or MAX-LIKE phase material of M_{b+1}A₂X may include an extra A layer interleaved between the M₆X octahedra, compared to M_{b+1}AX_{f}.

The dopant may act as a strengthening and/or alloying element. In one example, the dopant is used in the M site atoms to improve and tune mechanical and physical properties of the MAX or MAX-LIKE phase. For example, Mo, Mn, and/or Ti may be utilized as doping elements (J). In another example, dopants with similar crystal structures and atomic distances to elements in the MAX or MAX-LIKE phase are more consistent alloying elements. For example, the dopant J may be the same element as element M. The dopant J may be the same element as the element A. Strengthening and/or improving the mechanical properties of the MAX or MAX-LIKE phase may improve performance and efficiency for high-temperature applications. In one example, the dopant may strengthen the MAX or MAX-LIKE phase material sufficient to improve performance in a RWGS or DRM reaction. Improving performance may include one or more of improving carbon dioxide conversion, reducing methanol production, reducing methane production, improving run-times, decreasing overall reaction temperature, increasing operating pressure and decreasing coking.

The MAX or MAX-LIKE phase material may include one or more layers. The one or more layers may increase the area of active sites to improve catalytic performance. In one example, the nano-scale layered structure of the MAX or MAX-LIKE phase material increases the available active sites by creating step-wise facets. This may facilitate ion exchange and the kinetics of reactions. Multiple layers may assist in stabilizing the structure and increasing the number of active sites. In another example, if the corners or large face facets of the planes are the most active, the number of active sites may be increased by exfoliation. The one or more layers may include two or more different (distinct) MAX or MAX-LIKE phase materials. For example, two or more distinct MAX or MAX-LIKE phase materials may be in contact with each other to increase the area of active sites. The substrate may be in contact with one MAX or MAX-LIKE phase material, or the substrate may be in contact with two or more distinct MAX or MAX-LIKE phase materials.

The MAX or MAX-LIKE phase material of Formula 1 may be precursors to one or more active species that may form upon degradation. The MAX or MAX-LIKE phases may be layered and can be exfoliated (e.g., partially exfoliated) or processed into monolayer sheets. In one example, heating the material of Formula 1 can exfoliate the edges of the catalytic materials. In this example, the exfoliation may generate an increased area of active sites for the catalytic process. For example, active sites beyond the top and edge sites may be generated by exfoliation. This increased area of active sites may improve catalytic performance, such as carbon dioxide conversion to carbon monoxide. In one example, the exfoliation or degradation of the MAX or MAX-like materials may form a material including the formula: M_{b+1}X_{f}, where b is either 1, 2, or 3 and f is either 1, 2, 3, or 4. This material may form fully exfoliated layers on the surface of the material.

The one or more active species that may form upon degradation include oxides and/or oxycarbides. In one example, oxides and/or oxycarbides may form on one of the crystal faces of the active MAX or MAX-LIKE phase catalyst. Since the surface of the catalyst interacts with the reactants in the chemical reaction, the surface may include different or the same species as the bulk of the catalyst. In one example, the bulk of a material including carbide may assist in stabilizing surface oxides or oxycarbides which would have difficulty forming in the bulk material.

In some embodiments, the catalysts include catalytically active material(s) (e.g., one or more MAX or MAX-LIKE phase materials) secured to a solid support material. Accordingly, the catalyst may include one or more MAX or MAX-LIKE phase materials and one or more support materials. The exact type of support material used in the catalysts may depend upon the needs of a given application, but some non-limiting examples of support materials include metallic or non-metallic nitrides, carbides, oxides, oxynitrides, oxycarbides, metal alloys, silica, alkaline earth oxides, alkali metal oxides, zirconia, titania, and combinations thereof. The support may include alumina. Further non-limiting examples of potentially suitable catalyst support materials include alumina (e.g., alpha, beta, delta, theta, gamma, and intermediate phase alumina), silicon carbide (e.g., alpha or beta phase silicon carbide), boron nitride (e.g., hexagonal or cubic phase boron nitride), mullite, steatite, aluminum nitride, aluminum oxynitride, foamed or high-surface area metals (e.g., nickel and copper), silicon, alloys of multiple metals, and composites thereof. In some applications, the support material is, itself, catalytically active and participates in the conversion of reactant(s) to product(s) during a reaction (e.g., a RWGS and/or a DRM reaction).

In one example, the wt. % of the MAX or MAX-LIKE phase material of the total catalyst weight may range from about 0 wt. % to about 100 wt. %. In another example, the wt. % of the MAX or MAX-LIKE phase material of the total catalyst weight may range from about 2 wt. % to about 100 wt. %. In yet another example, the wt. % of the MAX or MAX-LIKE phase material of the total catalyst weight may range from about 5 wt. % to about 90 wt. %. In some embodiments, the catalysts are formed into predetermined shapes. For example, the catalysts can take the form of spherical particles or beads, porous beads, pellets, tubes, Raschig rings, Super Raschig rings, Pall rings, Białecki rings, extrudates, lobes, saddles, and/or other shapes.

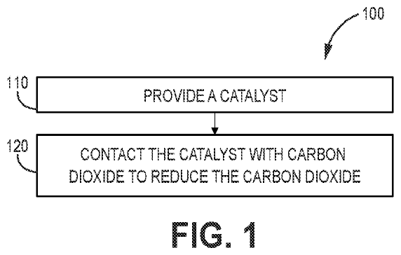

Referring to FIG. 1, a method 100 of performing a carbon dioxide reduction reaction is illustrated according to some embodiments. Method 100 includes the following steps:

STEP 110, PROVIDE A CATALYST, includes providing a catalyst of the present disclosure, such as a catalyst including the chemical formula of Formula 1. For example, the catalyst may include M_{b+1}A_{d}JₑX_{f}, where M is a transition metal (e.g., scandium, yttrium, lutetium, titanium, zirconium, hafnium, vanadium, niobium, tantalum, chromium, molybdenum, tungsten, manganese, or iron); A is a Group A element (e.g., iridium, palladium, copper, gold, zinc, cadmium, aluminum, gallium, indium, thallium, silicon, germanium, tin, lead, phosphorous, arsenic, bismuth, or sulfur); J is a dopant; and X is either carbon or nitrogen. In M_{b+1}A_{d}JₑX_{f}, b is either 1, 2, or 3; d is either 0, 1, 2, or 3; e is either 0, 1, 2, or 3; and f is either 1, 2, 3, or 4.

J may be a dopant selected from one or more of scandium, yttrium, lutetium, titanium, zirconium, hafnium, vanadium, niobium, tantalum, chromium, molybdenum, tungsten, manganese, iron, iridium, palladium, copper, gold, zinc, cadmium, aluminum, gallium, indium, thallium, silicon, germanium, tin, lead, phosphorous, arsenic, bismuth, sulfur, carbon, and nitrogen. J may be a dopant selected from two or more of scandium, yttrium, lutetium, titanium, zirconium, hafnium, vanadium, niobium, tantalum, chromium, molybdenum, tungsten, manganese, iron, iridium, palladium, copper, gold, zinc, cadmium, aluminum, gallium, indium, thallium, silicon, germanium, tin, lead, phosphorous, arsenic, bismuth, sulfur, carbon, and nitrogen. J may be a dopant selected from a transition metal such as scandium, yttrium, lutetium, titanium, zirconium, hafnium, vanadium, niobium, tantalum, chromium, molybdenum, tungsten, manganese, or iron. J may be a dopant selected from a group A element such as iridium, palladium, copper, gold, zinc, cadmium, aluminum, gallium, indium, thallium, silicon, germanium, tin, lead, phosphorous, arsenic, bismuth, or sulfur.

The catalyst may include the following formula: M_{b+1}AX_{f}, where b is either 1, 2, or 3 and f is either 1, 2, 3, or 4. The catalyst may include the following formula: M_{b+1}A_{d}X, where b is either 1, 2, or 3 and d is either 1, 2, or 3. The catalyst may include the following formula: M_{b+1}A_{d}JX_{f}, where b is either 1, 2, or 3; d is either 1, 2, or 3; and f is either 1, 2, 3, or 4. The catalyst may include the following formula: M_{b+1} X_{f}, where b is either 1, 2, or 3 and f is either 1, 2, 3, or 4.

The catalyst may include catalytically active material(s) (e.g., one or more MAX or MAX-LIKE phase materials) secured to a solid support material. Securing may include placing the one or more MAX or MAX-LIKE phase materials in physical contact with the solid support material. Securing may include chemically reacting and/or co-extruding the solid support material and the MAX or MAX-LIKE phase material(s). Since the solid support material and the MAX or MAX-LIKE phase material(s) may be co-extruded, these two or more materials may merge together to form a single structure. The solid support material and the MAX or MAX-LIKE phase material(s) may form a homogenous structure. The MAX or MAX-LIKE phase material(s) may be secured within the solid support material, such as within pores of the solid support material. The MAX or MAX-LIKE phase material(s) may be secured to the solid support material sufficient for a multilayer structure. This multilayer structure may include a solid support material layer in between (or substantially surrounded by) two or more MAX or MAX-LIKE phase material(s) layers.

The exact type of support material used in the catalysts may depend upon the needs of a given application, but some non-limiting examples of solid support materials include metallic or non-metallic nitrides, carbides, oxides, oxynitrides, oxycarbides, metal alloys, silica, alkaline earth oxides, alkali metal oxides, zirconia, titania, and combinations thereof. Further non-limiting examples of potentially suitable catalyst support materials include alumina (e.g., alpha, beta, delta, theta, gamma, and intermediate phase alumina), silicon carbide (e.g., alpha or beta phase silicon carbide), boron nitride (e.g., hexagonal or cubic phase boron nitride), mullite, steatite, aluminum nitride, aluminum oxynitride, foamed or high-surface area metals (e.g., nickel and copper), silicon, alloys of multiple metals, and composite thereof;

STEP 120, CONTACT THE CATALYST WITH CARBON DIOXIDE TO REDUCE THE CARBON DIOXIDE, includes contacting the catalyst, such as a catalyst including the MAX or MAX-LIKE phase material of Formula 1, with carbon dioxide to reduce the carbon dioxide. The carbon dioxide reduction reaction may produce carbon monoxide. In some embodiments, the present disclosure includes methods of performing a RWGS reaction where the catalysts catalyze the reduction of carbon dioxide and the oxidation of hydrogen. In some embodiments, the present disclosure includes methods of performing a DRM reaction where the catalysts catalyze the reaction of carbon dioxide and the oxidation of methane.

In some embodiments, method 100 includes performing a RWGS reaction. The methods include providing a catalytic material according to an embodiment of the disclosure described herein and contacting the catalytic material with carbon dioxide and hydrogen to produce carbon monoxide and water. In some embodiments, method 100 includes performing a DRM reaction. The methods include providing a catalytic material according to an embodiment of the disclosure described herein and contacting the catalytic material with methane and carbon dioxide to produce hydrogen and carbon monoxide.

In some embodiments, method 100 of performing a carbon dioxide reduction reaction includes contacting the catalyst with carbon dioxide at a temperature that is between about 100° C. and about 1,400° C., such as at a temperature of about 100° C., 150° C., 200° C., 250° C., 300° C., 350° C., 400° C., 450° C., 500° C., 550° C., 600° C., 650° C., 700° C., 750° C., 800° C., 850° C., 900° C., 950° C., 1000° C., 1050° C., 1100° C., 1150° C., 1200° C., 1250° C., 1300° C., 1350° C., 1400° C., or at a temperature or temperature range between any two of these listed temperatures. For example, carbon dioxide may contact the catalyst at a temperature that is between 300° C. and 1,400° C. or between 300° C. and 800° C.

In one example, the catalyst may be utilized for the RWGS and/or DRM reaction operated at a temperature ranging from about 300° C. to 1200° C. In another example, the catalyst may be utilized for the RWGS and/or DRM reaction operated at a temperature ranging from about 400° C. to 1100° C. In yet another example, the catalyst may be utilized for the RWGS and/or DRM reaction operated at a temperature ranging from about 500° C. to 800° C. For example, the catalyst may be utilized for the RWGS and/or DRM reaction operated at a temperature of about 550° C., about 600° C., about 650° C., about 700° C., about 750° C., about 800° C., about 850° C., or temperatures therebetween. The catalyst may be utilized for the RWGS and/or DRM reaction operated at a temperature below 850° C., below 800° C., below 750° C., or below 700° C. The catalyst may be utilized for the RWGS and/or DRM reaction operated at a temperature above 400° C., above 450° C., above 500° C., or above 550° C.

Catalysts of the present disclosure are capable of catalyzing reactions at various operating pressures. In one example, the catalyst may be utilized for method 100 (such as the RWGS and/or DRM reaction) operated at a pressure ranging from about 1 bar to about 40 bar. In another example, the catalyst may be utilized for the RWGS and/or DRM reaction operated at a pressure ranging from 1 bar to 10 bar. In yet another example, the catalyst may be utilized for the RWGS and/or DRM reaction operated at a pressure ranging from 1 bar to 4 bar. The catalyst may be utilized for the RWGS and/or DRM reaction operated at a pressure above 1 bar, above 2 bar, above 3 bar, above 4 bar, or above 5 bar.

The catalyst may be used in various types of reactor vessels. The catalyst may be utilized in two or more connected reactor vessels, wherein each of the two or more connected reactor vessels operate at different temperatures. Each reactor vessel may be operated at a temperature ranging from about 300° C. to about 1200° C. Examples of reactor vessels may include an isothermal reactor and a thermal gradient reactor. For example, the catalyst may be used in an isothermal reactor at a temperature setpoint, such as between 500° C. and 800° C. The catalyst may be utilized in a single reactor with one or more reaction zones, wherein the one or more reaction zones are configured to establish a thermal gradient along the length of the chamber. The catalyst may be utilized for two or more discrete reaction zones, wherein the two or more discrete reaction zones form a thermal gradient. For example, the two or more discrete reaction zones may be separated from each other and may operate at different temperatures. The reactor vessels of the present disclosure may be utilized for the RWGS and/or DRM reaction.

In some embodiments, the methods (such as method 100) of performing carbon dioxide reduction reactions have a carbon dioxide conversion value of between 5% and 100%, where CO₂ conversion is defined according to the following Equation 3:

$${CO}_{2} Conversion = \frac{Moles of CO Output}{Moles of {CO}_{2} Input} \qquad ( Equation 3 )$$

In some embodiments, the catalysts and methods can achieve a CO₂ conversion of 5%, 10%, 15%, 20%, 25%, 30%, 35%, 40%, 45%, 50%, 55%, 60%, 65%, 70%, 75%, 80%, 85%, 90%, 95%, 100%, or any amount or range between any two of these listed conversion amounts. In some embodiments, the catalysts and methods can achieve a CO₂ conversion based on the limits of thermodynamics. For example, the methods can achieve a CO₂ conversion of at least 30%, of between 5% and 70%, of between 15% and 25%, or of between 17% and 24.7%.

In one example, the catalyst and methods can achieve a CO₂ conversion in a RWGS reaction of at least 50% at a temperature of 500° C. and a pressure of 1 bar. In another example, the catalyst and methods can achieve a CO₂ conversion in a RWGS reaction of at least 60% at a temperature of 800° C. and a pressure of 1 bar. In another example, the catalyst and methods can achieve a CO₂ conversion in a RWGS reaction between 40% and 65% at temperatures ranging from 500° C. to 800° C. and a pressure of 1 bar. In yet another example, the catalyst and methods can achieve a CO₂ conversion in a RWGS reaction of at least 40%, at least 45%, at least 50%, at least 55%, or at least 60% at a temperature above 500° C. and a pressure of 1 bar. In yet another example, the catalyst and methods can achieve a CO₂ conversion in a RWGS reaction of at least 40%, at least 45%, at least 50%, at least 55%, or at least 60% at a temperature below 800° C. and a pressure of 1 bar.

Importantly, the catalyst of the present disclosure is capable of catalyzing the reduction of carbon dioxide with excellent stability and carbon dioxide conversion. These catalysts may be used for the RWGS and/or DRM reaction. Further, the catalyst of the present disclosure provides a decreased rate of coking and sintering compared to conventional catalysts. This catalyst may include an increased surface area due to the layered structure of the MAX or MAX-LIKE phase material. This increased surface area leads to increased active sites for catalytic conversion and improves performance.

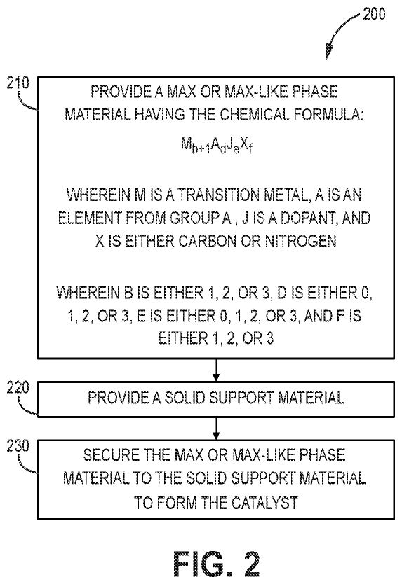

Referring to FIG. 2, a method 200 of preparing a catalyst is illustrated, according to some embodiments. Method 200 includes the following steps:

STEP 210, PROVIDE A MAX OR MAX-LIKE PHASE MATERIAL HAVING THE CHEMICAL FORMULA: M_{b+1}A_{d}JₑX_{f}, wherein M is a transition metal, A is an element from group A, J is a dopant, and X is either carbon or nitrogen, wherein b is either 1, 2, or 3, d is either 0, 1, 2, or 3, e is either 0, 1, 2, or 3, and f is either 1, 2, 3, or 4. In one example, M is selected from scandium, yttrium, lutetium, titanium, zirconium, hafnium, vanadium, niobium, tantalum, chromium, molybdenum, tungsten, manganese, and iron. In another example, A is selected from iridium, palladium, copper, gold, zinc, cadmium, aluminum, gallium, indium, thallium, silicon, germanium, tin, lead, phosphorous, arsenic, bismuth, and sulfur. Hence, the MAX or MAX-LIKE phase material may be any material of the present disclosure.

J may be a dopant selected from one or more of scandium, yttrium, lutetium, titanium, zirconium, hafnium, vanadium, niobium, tantalum, chromium, molybdenum, tungsten, manganese, iron, iridium, palladium, copper, gold, zinc, cadmium, aluminum, gallium, indium, thallium, silicon, germanium, tin, lead, phosphorous, arsenic, bismuth, sulfur, carbon, and nitrogen. J may be a dopant selected from two or more of scandium, yttrium, lutetium, titanium, zirconium, hafnium, vanadium, niobium, tantalum, chromium, molybdenum, tungsten, manganese, iron, iridium, palladium, copper, gold, zinc, cadmium, aluminum, gallium, indium, thallium, silicon, germanium, tin, lead, phosphorous, arsenic, bismuth, sulfur, carbon, and nitrogen. J may be a dopant selected from a transition metal such as scandium, yttrium, lutetium, titanium, zirconium, hafnium, vanadium, niobium, tantalum, chromium, molybdenum, tungsten, manganese, or iron. J may be a dopant selected from a group A element such as iridium, palladium, copper, gold, zinc, cadmium, aluminum, gallium, indium, thallium, silicon, germanium, tin, lead, phosphorous, arsenic, bismuth, or sulfur.

The MAX or MAX-LIKE phase material may be any MAX or MAX-LIKE phase material of the present disclosure. For example, the MAX or MAX-LIKE phase material may include the following formula: M_{b+1}AX_{f}, where b is either 1, 2, or 3 and f is either 1, 2, 3, or 4. The MAX or MAX-LIKE phase material may include the following formula: M_{b+1}A_{d}X, where b is either 1, 2, or 3 and d is either 1, 2, or 3. The MAX or MAX-LIKE phase material may include the following formula: M_{b+1}A_{d}JX_{f}, where b is either 1, 2, or 3; d is either 1, 2, or 3; and f is either 1, 2, 3, or 4. The MAX or MAX-LIKE phase material may include the following formula: M_{b+1}X_{f}, where b is either 1, 2, or 3 and f is either 1, 2, 3, or 4.

STEP 220, PROVIDE A SOLID SUPPORT MATERIAL, includes providing a solid support material, such as alumina. The solid support material may include one or more of metallic or non-metallic nitrides, carbides, oxides, oxynitrides, oxycarbides, metal alloys, silica, alkaline earth oxides, alkali metal oxides, zirconia, titania, and combinations thereof. The solid support material may include one or more of alumina (e.g., alpha, beta, delta, theta, gamma, and intermediate phase alumina), silicon carbide (e.g., alpha or beta phase silicon carbide), boron nitride (e.g., hexagonal or cubic phase boron nitride), mullite, steatite, aluminum nitride, aluminum oxynitride, foamed or high-surface area metals (e.g., nickel and copper), silicon, alloys of multiple metals, and composite thereof. The solid support material may include one or more of alpha alumina, beta alumina, delta alumina, theta alumina, gamma alumina, and intermediate phase alumina. The solid support material may include alpha phase silicon carbide and/or beta phase silicon carbide.

STEP 230, SECURE THE MAX OR MAX-LIKE PHASE MATERIAL TO THE SOLID SUPPORT MATERIAL TO FORM THE CATALYST, includes securing the MAX or MAX-LIKE phase material (such as the material of Formula 1) to the solid support material to form the catalyst. Securing may include placing the MAX or MAX-LIKE phase material and the solid support material in contact. Securing may include contacting the solid support material with a MAX or MAX-LIKE phase powder. Securing may include co-extruding the solid support material and the MAX or MAX-LIKE phase material. In one example, securing may include co-extruding the solid support material and the MAX or MAX-LIKE phase material, wherein the solid support material and the MAX or MAX-LIKE phase material are mixed together before being co-extruded. In another example, securing the catalytically active material (such as the MAX or MAX-LIKE phase material) to the support material can include mixing the catalytically active material with the support material and then extruding the mixture to create a desired catalytic form (e.g., beads, rings, or any of the other forms described above).

In one example, securing the MAX or MAX-LIKE phase material to the solid support material may include securing one MAX or MAX-LIKE phase material to the solid support material. In another example, securing the MAX or MAX-LIKE phase material to the solid support material may include securing two or more distinct MAX or MAX-LIKE phase materials to the solid support material sufficient for the two or more distinct MAX or MAX-LIKE phase materials to be in contact with the solid support material. In yet another example, securing the MAX or MAX-LIKE phase material to the solid support material includes tableting the materials. These materials (such as powders) may be mixed together and compressed to form the catalysts of the present disclosure. In one example, direct compression may be utilized to form the catalysts of the present disclosure.

Method 200 may further include providing a binder and securing the MAX or MAX-LIKE phase material to the support material. The binder may be used to secure the MAX or MAX-LIKE phase material to the solid support material. Examples of such binder materials include alumina or silica. The binder material can be mixed with the catalytically active material powder and/or particulate support material to form the catalyst. For example, alumina and/or silica powder can be mixed with a catalytically active material powder. The mixture of catalytically active material powder and the alumina and/or silica powder can be pressed and/or tableted, heat cured, extruded, etc. to form the catalyst. In other embodiments, the binder material is sprayed onto catalytically active material particles and/or particulate support material and then dried (e.g., in an oven, kiln, or furnace) to form catalyst particles.

### EXAMPLES

### Example 1: Catalyst Preparation

A catalyst was prepared by coating α-alumina beads with Mo₂InC powder. Porous alumina catalyst support beads, having an average diameter of about 2.5 mm and a median pore diameter of about 0.2 microns. The beads were placed within a vial with loose Mo₂InC powder. The Mo₂InC powder was silvery grey in color, had a purity of ~99%, and an average particle size of between 40-60 microns. The vial was placed in a continuous rotation mixer and rotated for 10 minutes, thereby producing Mo₂InC:alumina catalyst beads.

A molybdenum carbide (Mo₂C) catalyst was also prepared in a similar manner. Specifically, 2 mm alumina bead supports were continuously rotated with Mo₂C powder for 10 minutes to produce Mo₂C:alumina catalyst beads.

An indium oxide (In₂O₃) catalyst was also prepared using a wet-impregnation method to deposit the indium oxide in the pores of a ceramic support. Indium nitrate salts were dissolved in distilled water, and the resulting solution stirred with alumina beads. The salt/bead mixture was sonicated and then subjected to calcination in a furnace. In the furnace, the salt/bead mixture was heated to a temperature of 300° C. for one hour followed by heating to a temperature of 600° C. for two hours. The calcinated beads were then slowly cooled down to room temperature inside the furnace, resulting in In₂O₃:alumina catalyst beads.

Mo₂TiAlC₂, Mo₂Ti₂AlC₃, Mo₂Ga₂C, and Ti₂SnC were tested in the powder form. These materials were tested without a solid support material.

### Example 2: SEM Analysis of Mo₂InC

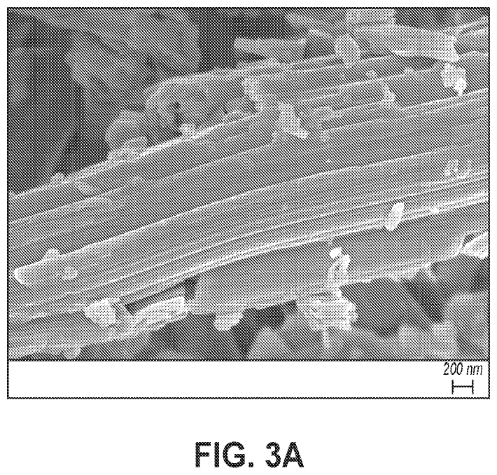

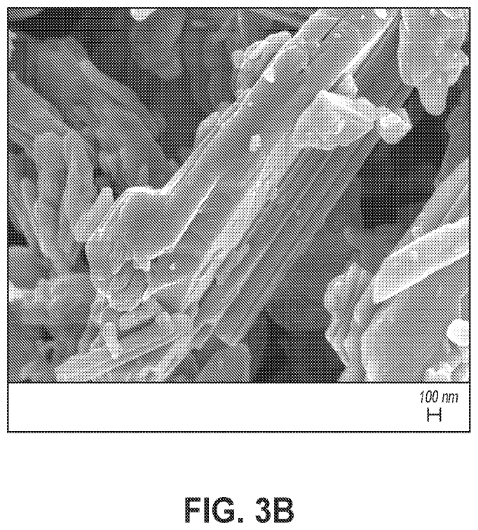

FIG. 3A illustrates an SEM image of one embodiment of a catalyst, according to some embodiments. In FIG. 3A, the MAX or MAX-LIKE phase material includes Mo₂InC, and the support includes silicon nitride. Mo₂InC was mechanically coated on the surface of the silicon nitride. Highly smooth silicon nitride was utilized as a support to analyze the Mo₂InC nanolayers. As shown in FIG. 3A, the Mo₂InC MAX or MAX-LIKE phase material includes multiple nanolayers.

FIG. 3B illustrates an SEM image of one embodiment of a catalyst, according to some embodiments. In FIG. 3B, the MAX or MAX-LIKE phase material includes Mo₂InC, and the support includes silicon nitride. Mo₂InC was mechanically coated on the surface of the silicon nitride. Highly smooth silicon nitride was utilized as a support to analyze the Mo₂InC nanolayers. As shown in FIG. 3B, the Mo₂InC MAX or MAX-LIKE phase material includes multiple nanolayers.

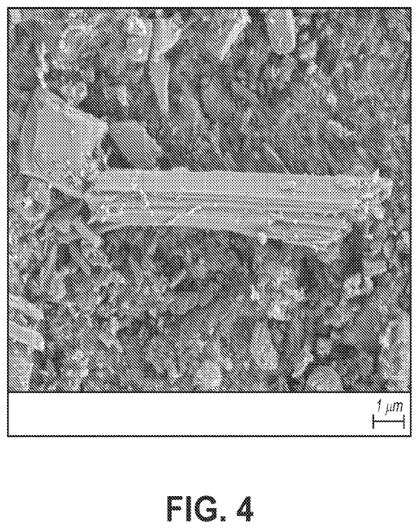

FIG. 4 illustrates an SEM image of one embodiment of a catalyst, according to some embodiments. FIG. 4 illustrates a Mo₂InC nanolayered structure coated on alumina, after catalytic performance and stability testing. The layered structure is shown for the catalyst, even after catalytic performance and stability testing. This catalytic performance and stability testing included testing the catalyst under RWGS conditions.

### Example 3: Carbon Dioxide Conversion and Selectivity Testing in a RWGS Reaction

In a RWGS reaction scheme, the carbon dioxide conversion of three catalytic materials was tested by exposing each of the catalytic materials to continuous flows of hydrogen and carbon dioxide gas at temperatures ranging from ~250° C. to ~800° C., while monitoring the amount of carbon monoxide in the reactor output stream. One of the three catalytic materials tested was the Mo₂InC:alumina beads described above, which is a catalyst. Mo₂C:alumina beads and In₂O₃:alumina beads were also tested. Naked alumina catalytic support beads (i.e., support beads without any additional catalytic materials applied) were also tested.

The amount of methane and methanol in the reactor output stream was also monitored. The presence of methane and methanol in the reactor output stream is an indication that side reactions are occurring within the reactor and provides a gauge of the selectivity of the catalyst for carbon monoxide production.

Five milliliters of each species of catalyst was packed within a stainless steel reactor, which was sufficient to form a single catalyst layer within the reactor's disk-shaped or tube reaction chamber. At temperatures below 600° C., a stainless steel reactor was used for alumina testing. At temperatures above 600° C., an Inconel reactor was utilized for alumina testing. At these elevated temperatures, 16 grams of alumina was utilized. Hydrogen was supplied to the catalyst material at a rate of 6 mL/min at 0 psig while the carbon dioxide was supplied at a rate of 3 mL/min at 0 psig, thereby providing a 2:1 volumetric ratio of hydrogen to carbon dioxide in the feed stream to the reactor. Table 1 provides a summary of the experimental parameters that were used during the test:

TABLE 1
Experimental Parameters of RWGS Reaction Testing

| | Volume of | Gas Hourly | H₂ to CO₂ |
|---|---|---|---|
| Catalyst | Catalyst | Space | volumetric |
| Species | Tested (mL) | Velocity (hr⁻¹) | ratio in feed |
| In₂O₃ | 5 | 139 | 2:1 |
| Mo₂C | 5 | 82 | 2:1 |
| Mo₂InC | 5 | 129 | 2:1 |

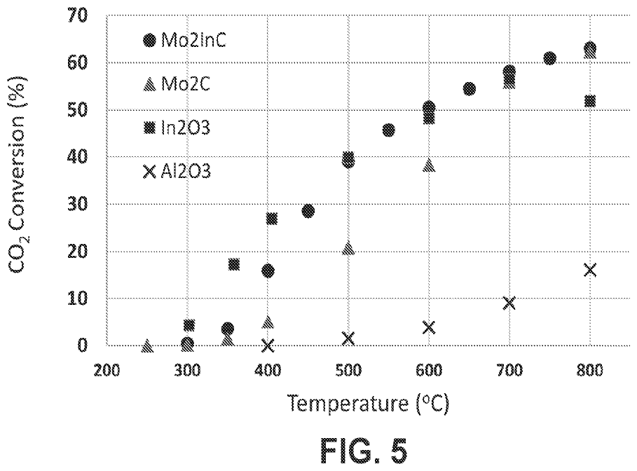

FIG. 5 illustrates a graph of carbon dioxide conversion measurements by various catalytic materials during a catalytic test at 1 bar, according to some embodiments. FIG. 5 also illustrates the conversion amounts measured for the naked alumina support beads (indicated in FIG. 5 as “Al₂O₃”). At a temperature of ~600° C., the carbon dioxide conversion provided by the Mo₂InC catalyst exceeded that of the Mo₂C and In₂O₃ catalysts, with the Mo₂InC catalyst providing a conversion of ~52% and the Mo₂C and In₂O₃ catalysts providing conversions of ~38% and ~49%, respectively. The Mo₂InC catalyst showed surprisingly higher carbon monoxide production at all temperatures between ~550° C. and ~800° C. At ~700° C., the carbon dioxide conversion provided by Mo₂InC was ~58%, while the conversions provided by Mo₂C and In₂O₃ were ~55% and ~56%, respectively.

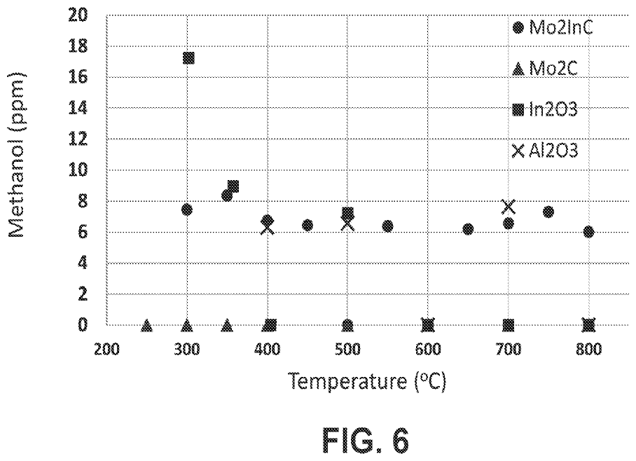

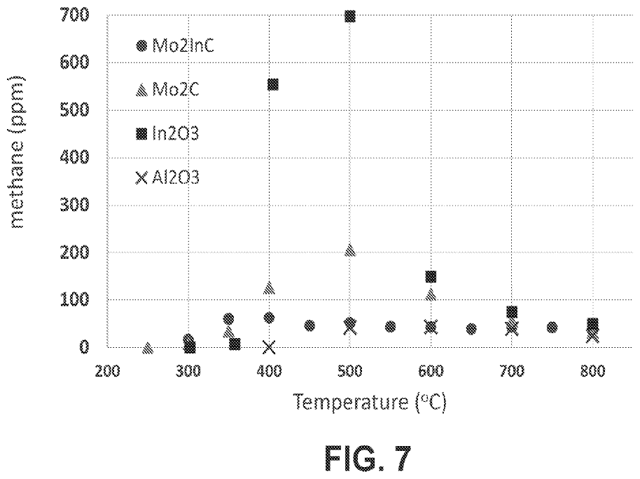

FIG. 6 illustrates a graph of the amount of methanol generated by various catalytic materials at 1 bar, according to some embodiments. FIG. 7 illustrates a graph of the amount of methane generated by various catalytic materials at 1 bar, according to some embodiments. The data shows that the Mo₂InC catalyst provides good selectively for carbon monoxide, with the output stream of gas from that reactor contained less than 10 ppm methanol and less than 100 ppm methane across all temperatures that were tested.

The naked alumina support beads were tested up to a temperature of ~800° C. As can be seen in FIG. 5, the naked alumina support beads provided significantly lower CO₂ conversion levels below 800° C., relative to the other tested materials. As can be seen in FIG. 6 and FIG. 7, the naked alumina support beads also produced relatively low amounts of methanol and methane. At temperatures over 600° C., alumina may contribute to the overall carbon dioxide conversion.

### Example 4: Carbon Dioxide Conversion Testing of Various Catalysts

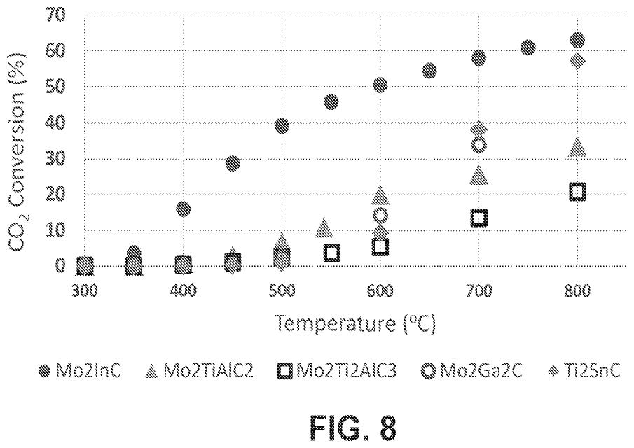

FIG. 8 illustrates a graph of the carbon dioxide conversion based on reaction temperature at 1 bar, by various catalytic materials, according to some embodiments.

Specifically, FIG. 8 illustrates the carbon dioxide conversions of Mo₂InC, Mo₂TiAlC₂, Mo₂Ti₂AlC₃, Mo₂Ga₂C, and Ti₂SnC. 200 mg of powder was utilized for each catalyst. The operating pressure of the reactor was 1 bar.

The carbon dioxide conversion values for Mo₂InC at 500° C., at 600° C., at 700° C., and at 800° C. were ~39%, ~50.5%, ~58%, and ~63%, respectively. The carbon dioxide conversion values for Mo₂TiAlC₂ at 500° C., at 600° C., at 700° C., and at 800° C. were ~6.7%, ~19.9%, ~25.6%, and ~33.3%, respectively. The carbon dioxide conversion values for Mo₂Ti₂AlC₃ at 500° C., at 600° C., at 700° C., and at 800° C. were ~2.5%, ~5.3%, ~13.4%, and ~20.7%, respectively. The carbon dioxide conversion values for Mo₂Ga₂C at 500° C., at 600° C., and at 700° C. were ~2.4%, ~14.1%, and ~33.9%, respectively. The carbon dioxide conversion values for Ti₂SnC at 500° C., at 600° C., at 700° C., and at 800° C. were ~1%, ~9.2%, ~38%, and ~57%, respectively.

### Example 5: Catalyst Stability Testing

The stability of the Mo₂InC catalyst in a RWGS reaction scheme was tested. Five milliliters of the catalyst was placed within a reactor. The reactor was fed a continuous gas flow of hydrogen and carbon dioxide at a 2:1 volumetric ratio, with a hydrogen volumetric feed rate of 12 mL/min at 0 psig and a carbon dioxide volumetric feed rate of 6 mL/min at 0 psig. The temperature of the reactor and feed gas was maintained at 650° C. and the carbon dioxide conversion measured continuously over the course of several hours.

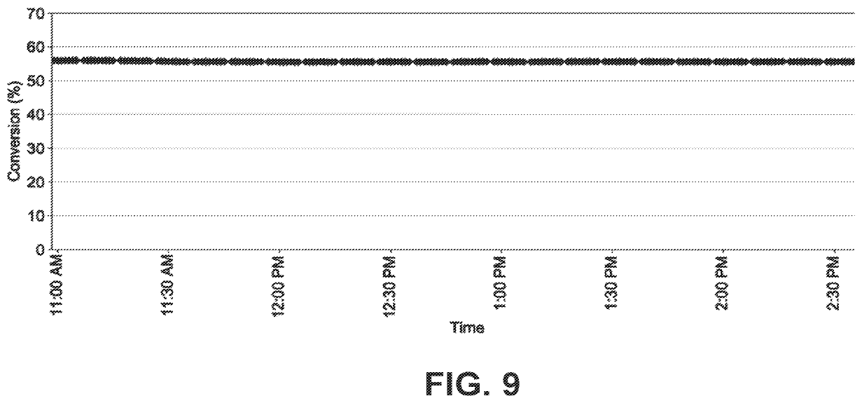

FIG. 9 illustrates a graph of carbon dioxide conversion measurements made during the catalytic stability test at 1 bar, according to some embodiments. After a relatively brief warm-up at the start of the test (not shown in the graph of FIG. 9), the carbon dioxide conversion jumped to ~57% and was constant for more than 3 hours. This data shows that the Mo₂InC catalyst is stable and durable in a RWGS reaction scheme conducted at 650° C.

### Discussion of Possible Embodiments

A solid catalyst for catalyzing the reduction of carbon dioxide includes a MAX or MAX-LIKE phase material having the chemical formula M_{b+1}A_{d}JₑX_{f}, wherein M is a transition metal, A is an element from Group A, J is a dopant, and X is either carbon or nitrogen, and wherein b is either 1, 2, or 3; d is either 0, 1, 2, or 3; e is either 0, 1, 2, or 3; and f is either 1, 2, 3, or 4.

The catalyst of the preceding paragraph can optionally include, additionally and/or alternatively any one or more of the following features, configurations and/or additional components.

M may be selected from the group including scandium, yttrium, lutetium, titanium, zirconium, hafnium, vanadium, niobium, tantalum, chromium, molybdenum, tungsten, manganese, and iron.

M may be selected from the group consisting of scandium, yttrium, lutetium, titanium, zirconium, hafnium, vanadium, niobium, tantalum, chromium, molybdenum, tungsten, manganese, and iron.

A may be selected from the group including iridium, palladium, copper, gold, zinc, cadmium, aluminum, gallium, indium, thallium, silicon, germanium, tin, lead, phosphorous, arsenic, bismuth, and sulfur.

A may be selected from the group consisting of iridium, palladium, copper, gold, zinc, cadmium, aluminum, gallium, indium, thallium, silicon, germanium, tin, lead, phosphorous, arsenic, bismuth, and sulfur.

J may be selected from the group including scandium, yttrium, lutetium, titanium, zirconium, hafnium, vanadium, niobium, tantalum, chromium, molybdenum, tungsten, manganese, iron, iridium, palladium, copper, gold, zinc, cadmium, aluminum, gallium, indium, thallium, silicon, germanium, tin, lead, phosphorous, arsenic, bismuth, sulfur, carbon, and nitrogen.

J may be selected from the group consisting of scandium, yttrium, lutetium, titanium, zirconium, hafnium, vanadium, niobium, tantalum, chromium, molybdenum, tungsten, manganese, iron, iridium, palladium, copper, gold, zinc, cadmium, aluminum, gallium, indium, thallium, silicon, germanium, tin, lead, phosphorous, arsenic, bismuth, sulfur, carbon, and nitrogen.

The MAX or MAX-LIKE phase material may include the chemical formula M_{b+1}A_{d}JₑX_{f}, wherein M is a transition metal, A is an element from Group A, J is a dopant, and X is either carbon or nitrogen, and wherein b is either 1, 2, or 3; d is either 1, 2, or 3; e is either 0, 1, 2, or 3; and f is either 1, 2, 3, or 4.

The MAX or MAX-LIKE phase material may include the chemical formula M_{b+1}AX_{f}, where b is either 1, 2, or 3 and f is either 1, 2, 3, or 4.

The MAX or MAX-LIKE phase material may be Mo₂InC.

The MAX or MAX-LIKE phase material may be positioned on a support material selected from one or more of a metallic or non-metallic nitride, a carbide, an oxide, an oxynitride, an oxycarbide, a metal alloy, silica, an alkaline earth oxide, an alkali metal oxide, zirconia, titania, alumina, silicon carbide, mullite, steatite, foamed metal, silicon, and composites thereof.

The support material may be shaped as a bead, a pellet, a tube, a Raschig ring, a Super Raschig ring, a Pall ring, a Bialecki ring, an extrudate, a lobe, or a saddle.

A method of performing a carbon dioxide reduction reaction includes providing a catalyst, wherein the catalyst includes: a MAX or MAX-LIKE phase material having the chemical formula M_{b+1}A_{d}JₑX_{f}, wherein M is a transition metal, A is an element from Group A, J is a dopant, and X is either carbon or nitrogen, and wherein b is either 1, 2, or 3; d is either 0, 1, 2, or 3; e is either 0, 1, 2, or 3; and f is either 1, 2, 3, or 4; and contacting the catalyst with carbon dioxide to reduce the carbon dioxide.

The method of the preceding paragraph can optionally include, additionally and/or alternatively any one or more of the following features, configurations and/or additional components.

The carbon dioxide reduction reaction may produce carbon monoxide.

Contacting the catalyst with the carbon dioxide may occur at a temperature of between 300° C. to 1,400° C.

The contact may occur at a temperature of between 300° C. and 800° C.

The carbon dioxide reduction reaction may include a carbon dioxide conversion of at least 30%.

The carbon dioxide reduction reaction may include a carbon dioxide conversion of between 5% and 70%.

Contacting the catalyst with the carbon dioxide may occur at a pressure ranging from about 1 bar to about 40 bar.

The MAX or MAX-LIKE phase material may include Mo₂InC.

The carbon dioxide reduction reaction may be a reverse water gas shift reaction.

The carbon dioxide reduction reaction may produce carbon monoxide and water.

The carbon dioxide reduction reaction may be a dry methane reforming reaction.

The carbon dioxide reduction reaction may produce carbon monoxide and hydrogen.

A method of preparing a catalyst includes providing a MAX or MAX-LIKE phase material having the chemical formula M_{b+1}A_{d}JₑX_{f}, wherein M is a transition metal, A is an element from Group A, J is a dopant, and X is either carbon or nitrogen, and wherein b is either 1, 2, or 3; d is either 0, 1, 2, or 3; e is either 0, 1, 2, or 3; and f is either 1, 2, 3, or 4; providing a solid support material; and securing the MAX or MAX-LIKE phase material to the solid support material to form the catalyst.

The method of the preceding paragraph can optionally include, additionally and/or alternatively any one or more of the following features, configurations and/or additional components.

M may be selected from the group including scandium, yttrium, lutetium, titanium, zirconium, hafnium, vanadium, niobium, tantalum, chromium, molybdenum, tungsten, manganese, and iron.

M may be selected from the group consisting of scandium, yttrium, lutetium, titanium, zirconium, hafnium, vanadium, niobium, tantalum, chromium, molybdenum, tungsten, manganese, and iron.

A may be selected from the group including iridium, palladium, copper, gold, zinc, cadmium, aluminum, gallium, indium, thallium, silicon, germanium, tin, lead, phosphorous, arsenic, bismuth, and sulfur.

A may be selected from the group consisting of iridium, palladium, copper, gold, zinc, cadmium, aluminum, gallium, indium, thallium, silicon, germanium, tin, lead, phosphorous, arsenic, bismuth, and sulfur.

J may be selected from the group including scandium, yttrium, lutetium, titanium, zirconium, hafnium, vanadium, niobium, tantalum, chromium, molybdenum, tungsten, manganese, iron, iridium, palladium, copper, gold, zinc, cadmium, aluminum, gallium, indium, thallium, silicon, germanium, tin, lead, phosphorous, arsenic, bismuth, sulfur, carbon, and nitrogen.

J may be selected from the group consisting of scandium, yttrium, lutetium, titanium, zirconium, hafnium, vanadium, niobium, tantalum, chromium, molybdenum, tungsten, manganese, iron, iridium, palladium, copper, gold, zinc, cadmium, aluminum, gallium, indium, thallium, silicon, germanium, tin, lead, phosphorous, arsenic, bismuth, sulfur, carbon, and nitrogen.

The MAX or MAX-LIKE phase material may include the chemical formula M_{b+1}A_{d}JₑX_{f}, wherein M is a transition metal, A is an element from Group A, J is a dopant, and X is either carbon or nitrogen, and wherein b is either 1, 2, or 3; d is either 1, 2, or 3; e is either 0, 1, 2, or 3; and f is either 1, 2, 3, or 4.

The MAX or MAX-LIKE phase material may include the chemical formula M_{b+1}AX_{f}, where b is either 1, 2, or 3 and f is either 1, 2, 3, or 4.

The MAX or MAX-LIKE phase material may include Mo₂InC.

The solid support material may include a metallic or non-metallic nitride, a carbide, an oxide, an oxynitride, an oxycarbide, a metal alloy, silica, an alkaline earth oxide, an alkali metal oxide, zirconia, titania, alumina, silicon carbide, mullite, steatite, foamed metal, silicon, and composites thereof.

The solid support material may include alumina.

The solid support material may be shaped as a bead, a pellet, a tube, a Raschig ring, a Super Raschig ring, a Pall ring, a Bialecki ring, an extrudate, a lobe, or a saddle.

Securing the MAX or MAX-LIKE phase material to the solid support material may include contacting the solid support material with a MAX or MAX-LIKE phase powder.

Securing the MAX or MAX-LIKE phase material to the solid support material may include co-extruding the solid support material and the MAX or MAX-LIKE phase material.

The solid support material and the MAX or MAX-LIKE phase material may be mixed together before being co-extruded.

The method may further include providing a binder and securing the MAX or MAX-LIKE phase material to the solid support material includes using the binder to secure the MAX or MAX-LIKE phase material to the solid support material.

While the disclosure has been described with reference to an exemplary embodiment(s), it will be understood by those skilled in the art that various changes may be made, and equivalents may be substituted for elements thereof without departing from the scope of the embodiment(s). In addition, many modifications may be made to adapt a particular situation or material to the teachings of the embodiment(s) without departing from the essential scope thereof. Therefore, it is intended that the disclosure is not limited to the disclosed embodiment(s), but that the disclosure will include all embodiments falling within the scope of the appended claims. Various examples have been described. These and other examples are within the scope of the following claims.

1. A catalyst for catalyzing the reduction of carbon dioxide, the catalyst comprising: a MAX or MAX-LIKE phase material having the chemical formula M_{b+1}A_{d}JₑX_{f},
wherein M is a transition metal, A is an element from Group A, J is a dopant, and X is either carbon or nitrogen, and
wherein b is either 1, 2, or 3; d is either 0, 1, 2, or 3; e is either 0, 1, 2, or 3; and f is either 1, 2, 3, or 4.

2. The catalyst according to claim 1, wherein M is selected from the group consisting of scandium, yttrium, lutetium, titanium, zirconium, hafnium, vanadium, niobium, tantalum, chromium, molybdenum, tungsten, manganese, and iron.

3. The catalyst according to claim 1, wherein A is selected from the group consisting of iridium, palladium, copper, gold, zinc, cadmium, aluminum, gallium, indium, thallium, silicon, germanium, tin, lead, phosphorous, arsenic, bismuth, and sulfur.

4. The catalyst according to claim 1, wherein J is selected from the group consisting of scandium, yttrium, lutetium, titanium, zirconium, hafnium, vanadium, niobium, tantalum, chromium, molybdenum, tungsten, manganese, iron, iridium, palladium, copper, gold, zinc, cadmium, aluminum, gallium, indium, thallium, silicon, germanium, tin, lead, phosphorous, arsenic, bismuth, sulfur, carbon, and nitrogen.

5. The catalyst according to claim 1, wherein the MAX or MAX-LIKE phase material includes the chemical formula M_{b+1}AX_{f}, where b is either 1, 2, or 3 and f is either 1, 2, 3, or 4.

6. The catalyst according to claim 1, wherein the MAX or MAX-LIKE phase material is Mo₂InC.

7. The catalyst according to claim 1, wherein the MAX or MAX-LIKE phase material is positioned on a support material selected from one or more of a metallic or non-metallic nitride, a carbide, an oxide, an oxynitride, an oxycarbide, a metal alloy, silica, an alkaline earth oxide, an alkali metal oxide, zirconia, titania, alumina, silicon carbide, mullite, steatite, foamed metal, silicon, and composites thereof.

8. A method of performing a carbon dioxide reduction reaction, the method comprising:
providing a catalyst, wherein the catalyst includes:
a MAX or MAX-LIKE phase material having the chemical formula M_{b+1}A_{d}JₑX_{f}, wherein M is a transition metal, A is an element from Group A, J is a dopant, and X is either carbon or nitrogen, and wherein b is either 1, 2, or 3; d is either 0, 1, 2, or 3; e is either 0, 1, 2, or 3; and f is either 1, 2, 3, or 4; and
contacting the catalyst with carbon dioxide to reduce the carbon dioxide.

9. The method according to claim 8, wherein the carbon dioxide reduction reaction produces carbon monoxide.

10. The method according to claim 8, wherein contacting the catalyst with the carbon dioxide occurs at a temperature of between 300° C. to 1,400° C.

11. The method according to claim 10, wherein the contacting occurs at a temperature of between 300° C. and 800° C.

12. The method according to claim 8, wherein the carbon dioxide reduction reaction has a carbon dioxide conversion of at least 30%.

13. The method according to claim 8, wherein contacting the catalyst with the carbon dioxide occurs at a pressure ranging from about 1 bar to about 40 bar.

14. The method according to claim 8, wherein the MAX or MAX-LIKE phase material is Mo₂InC.

15. A method of preparing a catalyst, the method comprising:
providing a MAX or MAX-LIKE phase material having the chemical formula M_{b+1}A_{d}JₑX_{f}, wherein M is a transition metal, A is an element from Group A, J is a dopant, and X is either carbon or nitrogen, and wherein b is either 1, 2, or 3; d is either 0, 1, 2, or 3; e is either 0, 1, 2, or 3; and f is either 1, 2, 3, or 4;
providing a solid support material; and
securing the MAX or MAX-LIKE phase material to the solid support material to form the catalyst.

16. The method according to claim 15, wherein M is selected from the group consisting of scandium, yttrium, lutetium, titanium, zirconium, hafnium, vanadium, niobium, tantalum, chromium, molybdenum, tungsten, manganese, and iron, and wherein A is selected from the group consisting of iridium, palladium, copper, gold, zinc, cadmium, aluminum, gallium, indium, thallium, silicon, germanium, tin, lead, phosphorous, arsenic, bismuth, and sulfur.

17. The method according to claim 15, wherein J is selected from the group consisting of scandium, yttrium, lutetium, titanium, zirconium, hafnium, vanadium, niobium, tantalum, chromium, molybdenum, tungsten, manganese, iron, iridium, palladium, copper, gold, zinc, cadmium, aluminum, gallium, indium, thallium, silicon, germanium, tin, lead, phosphorous, arsenic, bismuth, sulfur, carbon, and nitrogen.

18. The method according to claim 15, wherein the MAX or MAX-LIKE phase material includes the chemical formula M_{b+1}AX_{f}, where b is either 1, 2, or 3 and f is either 1, 2, 3, or 4.

19. The method according to claim 15, wherein the MAX or MAX-LIKE phase material is Mo₂InC.

20. The method of claim 15, wherein the solid support material includes a metallic or non-metallic nitride, a carbide, an oxide, an oxynitride, an oxycarbide, a metal alloy, silica, an alkaline earth oxide, an alkali metal oxide, zirconia, titania, alumina, silicon carbide, mullite, steatite, foamed metal, silicon, and composites thereof.
